(19) United States
(12) Patent Application Publication
(10) Pub. No.: US 2014/0199675 A1
(43) Pub. Date: Jul. 17, 2014

(54) SOCIAL NETWORK BASED EDUCATION INFRASTRUCTURE AND METHODS OF IMPLEMENTING AND USING SOCIAL NETWORK BASED EDUCATION INFRASTRUCTURES

(71) Applicant: Yeda Research and Development Co. Ltd., Rehovot (IL)

(72) Inventor: Daniel ZAJFMAN, Rehovot (IL)

(73) Assignee: Yeda Research and Development Co. Ltd., Rehovot (IL)

(21) Appl. No.: 14/153,037

(22) Filed: Jan. 12, 2014

Related U.S. Application Data
(60) Provisional application No. 61/751,881, filed on Jan. 13, 2013.

(51) Int. Cl. G09B 5/00

(52) U.S. Cl. CPC G09B 5/00
USPC 434/350

(57) ABSTRACT

A method for enabling users to offer educational support in response to a designation of instructor identifier (ID) tags associated with network accessible learning documents. The method comprises selecting by a first user using a first client terminal a network accessible learning document, associating an instructor ID tag indicative of the first user with the network accessible learning document, instructing a presentation of the instructor ID tag in association with the presentation of the network accessible learning document to a second user accessing the network accessible learning document via a second client terminal, identifying a user selection designating the instructor ID tag and made by the second user, and establishing a tutorial session which is based on an interactive communication connection between the first user and the second user.

### RELATED APPLICATION

This application claims the benefit of priority under 35 USC 119(e) of U.S. Provisional Patent Application No. 61/751,881 filed Jan. 13, 2013, the contents of which are incorporated herein by reference in their entirety.

### BACKGROUND

The present invention, in some embodiments thereof, relates to education systems and methods and, more specifically, but not exclusively, to systems and methods of establishing education infrastructure based on social network services.

A social network service uses software to build online social networks for communities of people who share interests and activities or who are interested in exploring the interests and activities of others. Most services are primarily web based and provide a collection of various ways for users to interact, such as chat, messaging, email, video, voice chat, file sharing, blogging, discussion groups, and so on. The main types of social networking services are those which contain directories of some categories, means to connect with friends (usually with self-description pages), and recommended systems linked to trust. Popular methods now combine many of these. There have been some attempts to standardize these services to avoid the need to duplicate entries of friends and interests, but this has led to some concerns about privacy.

Social networks connect people at low cost; this can be beneficial for entrepreneurs and small businesses looking to expand their contact base. These networks often act as a customer relationship management tool for companies selling products and services. Companies can also use social networks for advertising in the form of banners and text ads. Since businesses operate globally, social networks can make it easier to keep in touch with contacts around the world.

Social networks are beginning to be adopted by healthcare professionals as a means to manage institutional knowledge, disseminate peer to peer knowledge and to highlight individual physicians and institutions. The advantageous of using a dedicated medical social networking site is that all the members are screened against the state licensing board list of practitioners. Several websites are beginning to tap into the power of the social networking model for social good. Such models may be highly successful for connecting otherwise fragmented industries and small organizations without the resources to reach a broader audience with interested and passionate users. Users benefit by interacting with a likeminded community and finding a channel for their energy and giving.

For example, U.S. Pat. No. 8,271,516 teaches a social network service that provides trusted, timely and managed communications between a querying individual and an informed individual by optimizing distribution of queries to reflect a requisite amount of expertise necessary (i.e. interest, background, education, demographic attribute, etc.). Those candidate recipients with a rare level of expertise or specialization can specify a desired level of participation, which is respected. In order not to exhaust their availability, those who are less qualified or part of a larger demographic category appropriate for the query are selected to handle queries of lesser difficulty or less specialization. Anonymity if desired by the recipient party can be supported by increasing the pool of candidate recipients so that the querying party cannot reasonably ascertain who is responding. Timeliness of response, as well as satisfaction in the response, is tracked in order to affect redirection of a query.

### SUMMARY

According to some embodiments of the present invention, there is provided a method for enabling users to offer educational support in response to a designation of instructor identifier (ID) tags associated with network accessible learning documents. The method comprises selecting by a first user using a first client terminal a network accessible learning document, associating an instructor ID tag indicative of the first user with the network accessible learning document, instructing a presentation of the instructor ID tag in association with the presentation of the network accessible learning document to a second user accessing the network accessible learning document via a second client terminal, identifying a user selection designating the instructor ID tag and made by the second user, and establishing a tutorial session which is based on an interactive communication connection between the first user and the second user.

Optionally, the instructor ID tag is associated with a portion of a network accessible learning document; wherein the instructing comprises instructing a presentation of the instructor ID tag in association with the presentation of the portion to the second user.

Optionally, a ranking given to the first user by a plurality of users participating in a plurality of tutorial sessions therewith is presented in association with the instructor ID tag.

Optionally, the method comprises identifying a community to which both the first and second belongs and presenting an indication of the community to the second user in association with the instructor ID tag.

Optionally, the establishing comprises identifying support material loaded by the first user in relation to the network accessible learning document and presenting the support material to the second user during the tutorial session.

Optionally, the instructor ID tag is presented by a browser displaying the network accessible learning document while the network accessible learning document is displayed.

Optionally, network accessible learning document comprises a plurality of tag holders, the selecting is performed in response to a selection of one of the plurality of tag holders by the first user.

Optionally, the method comprises recoding the tutorial session and making the recorded tutorial session available to a third user who accesses the network accessible learning document via a third client terminal.

Optionally, the method comprises presenting an indication of a participation of the second user in the tutorial session to a third user accessing the network accessible learning document via a third client terminal.

Optionally, the learning document is managed by a teaching platform.

Optionally, the network accessible learning document is a page in multipage document, the network accessible learning document is one of a plurality of segments of the page where each the segment is associated with at least different instructor ID tag indicative of and added by at least additional user.

Optionally, the method comprises selecting the network accessible learning document by a plurality of third users using a plurality of different client terminals, associating a plurality of instructor ID tags each indicative of another of the plurality of third users, and instructing a presentation of the plurality of instructor ID tags in association with the presentation of the network accessible learning document to the second user during an access to the network accessible learning document. The user selection designating one of the pluralities of instructor ID tags.

Optionally, the instructor ID tag is added to a plurality of ID tags which are added by and indicative of a plurality of different users.

Optionally, the learning document is selected from a group consisting of a webpage, a scanned page of a book a pamphlet, a printed educational material, a portable document format (PDF) document, and a WORD document.

Optionally, the instructor ID tag is presented in association with the presentation of the network accessible learning document to a plurality of second users accessing the network accessible learning document via a plurality of different second client terminals.

More optionally, the identifying comprises identifying a plurality of user selections designating the instructor ID tag from the plurality of different second client terminals and the establishing comprises establishing the tutorial session with the plurality of second users as a multi participant session.

Optionally, the establishing comprises automatically forwarding to the first user a request message in response to the user selection, the request message indicates a request from at least one second user for an interactive tutorial pertaining to the network accessible learning document; wherein the establishing is performed based on the acceptance of the request.

Optionally, the method comprises scheduling a time for the tutorial session according to input received from at least one of the first user and the second user; wherein the establishing is automatically performed according to the scheduling.

According to some embodiments of the present invention, there is provided a system for enabling users to offer educational support in response to a selection of one or more instructor identifier (ID) tags associated with one or more network accessible learning documents. The system comprises a repository which documents a plurality of instructor ID tags each indicative of an association between one of a plurality of learning documents and one of a plurality of system users, each the instructor ID tag is set to be presented in association with a respective the learning document from the plurality of learning documents, a tagging module which allows each one of the plurality of system users to add at least one of the plurality of instructor ID tags to at least one of the plurality of learning documents, and an interactive communication connection module which receives via a network a user selection designating a certain of the plurality of instructor ID tags and triggers the establishing of a tutorial session between a tag selecting user who made the user selection and a system user of the plurality of system users which is associated with the certain instructor ID tag.

According to some embodiments of the present invention, there is provided a method adding a tutorial session support layer to a network accessible learning. The method comprises selecting a network accessible learning document by each of a plurality of contributing users in a plurality of separate events, associating a plurality of instructor ID tags with the network accessible learning document, each the instructor ID tag is further associated with one of the plurality of contributing users, instructing a presentation of the plurality of instructor ID tag in association with the presentation of the network accessible learning document on a client terminal to an additional user accessing the network accessible learning document, selecting a first of the plurality of instructor ID tags by the additional user, and establishing a tutorial session which is based on an interactive communication connection between the additional user and a first of the plurality of contributing users which is associated with the first instructor ID tag.

Optionally, each the instructor ID tags includes an indication of a ranking of a respective the contributing user.

Optionally, each of the instructor ID tags includes an indication of a current availability of a respective the contributing user.

Optionally, each the instructor ID tags includes an indication of a relation between a respective the contributing user and the additional user.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a schematic illustration of an infrastructure that includes a central unit of a system for matching system users for tutorial sessions based on selection of instructor ID tags in learning documents and network nodes that the central unit communicates with and/or refer to during an establishment of the tutorial sessions, according to some embodiments of the present invention;

FIG. 2 is a schematic illustration of an exemplary learning document having instructor ID tags, according to some embodiments of the present invention;

FIG. 3 is a process of establishing a tutorial session between a suitable instructor and one or more learner(s), according to some embodiments of the present invention;

FIGS. 4-5 are schematic illustrations of exemplary learning documents having instructor ID tags associated therewith, according to some embodiments of the present invention; and

FIG. 6 is a schematic illustration of an exemplary comparative presentation of rankings of a plurality of instructors from the same community, according to some embodiments of the present invention.

### DETAILED DESCRIPTION

The present invention, in some embodiments thereof, relates to education systems and methods and, more specifically, but not exclusively, to systems and methods of establishing education infrastructure based on social network services.

According to some embodiments of the present invention, there are provided methods and systems of establishing a tutorial session between a contributing system user who designated herself as an instructor of content in a network available learning document (or portion(s) thereof) (also referred to as instructor) and system user(s) who are interested in participating in a tutorial sessions led by the contributing system user (also referred to as learner). In use, instructor identifier (ID) tags, such as icons and/or images are added to network available learning document (or portion(s) thereof) by contributing system users. These instructor ID tags are respectively presented to system users who access the respective tagged network available learning documents. In response to a designation of the instructor ID tags by the accessing system users, tutorial sessions which are optionally based on an interactive communication connection, such as a multimedia conference connection are established. The methods and systems may be implemented to tag learning documents such as webpages, teaching platform educational material, chapters and/or any other segments of learning documents, for example electronic network accessible books and/or the like. Optionally, the instructor is ranked for her contribution.

These systems and methods may allow individuals in a community, which are optionally not teachers in this community, to participate in educational activities of the community by enrolling themselves as instructors who specialize in a content that is related to certain network available learning document(s). The community may be, for example, a nursery school, a class, a school, a university, alumni, a city, and/or a country. This education infrastructure allows individuals related to members of a community, for example parents and/or siblings of a member of a community, to participate in educational activities of the community by enrolling themselves as instructors.

Such systems and methods allow establishing a social network centered tutorial session(s) around a specific education material and/or a well-defined theme where system users help each other to understand and/or discuss the education material and/or to solve problems. This may be used to provide a human supported homework preparation experience that is motivated by social recognition, group activities, and/or relationships; prioritizes taking action, collaboration, and/or expressing enthusiasm. The education infrastructure may allow any system user to contribute to others in its own time and/or terms, optionally without receiving any payment.

The systems and methods allow creating a social network experience which is centered on a topic or a theme in a certain learning document, for example a specific page in a math book. The system may allow students to see which classmates are currently engaged in learning from the certain learning document. In such a manner, system users receive a real time indication about who is study and work on a task, such as homework.

The network experience provided by the systems and methods may give learning participants a sense of responsibility and participants who want to help, the possibility to do so without going through any “administrative” difficulties. Optionally, everyone can be registered as an instructor and make herself available to contribute to the education of other system users, for example members of his community.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

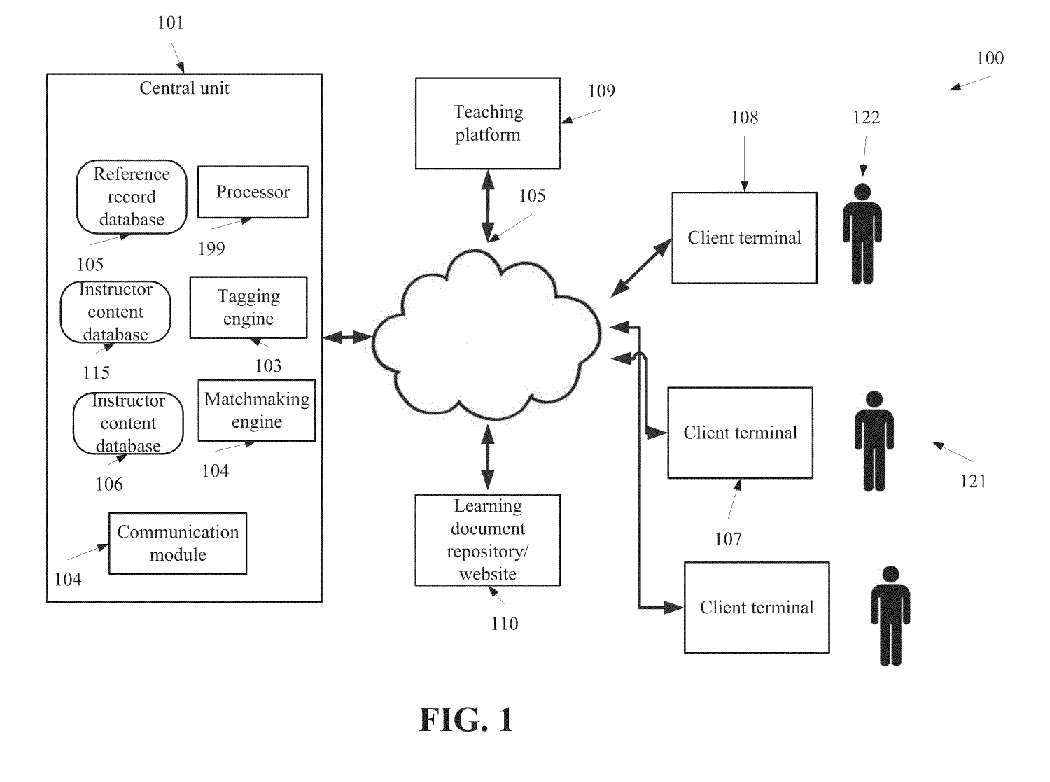

Reference is now made to FIG. 1, which is a schematic illustration of an education infrastructure 100 that includes a central unit 101 of a system for matching system users for tutorial sessions based on selection(s) of instructor identifier ID tags in learning documents and network nodes 107-110 that the central unit 101 communicates with and/or refer to during an establishment of the tutorial sessions, according to some embodiments of the present invention. The education infrastructure 100 allows a system user, such as 122, to add instructor ID tag(s) (e.g. reference icons and images) to one or more network available learning document(s).

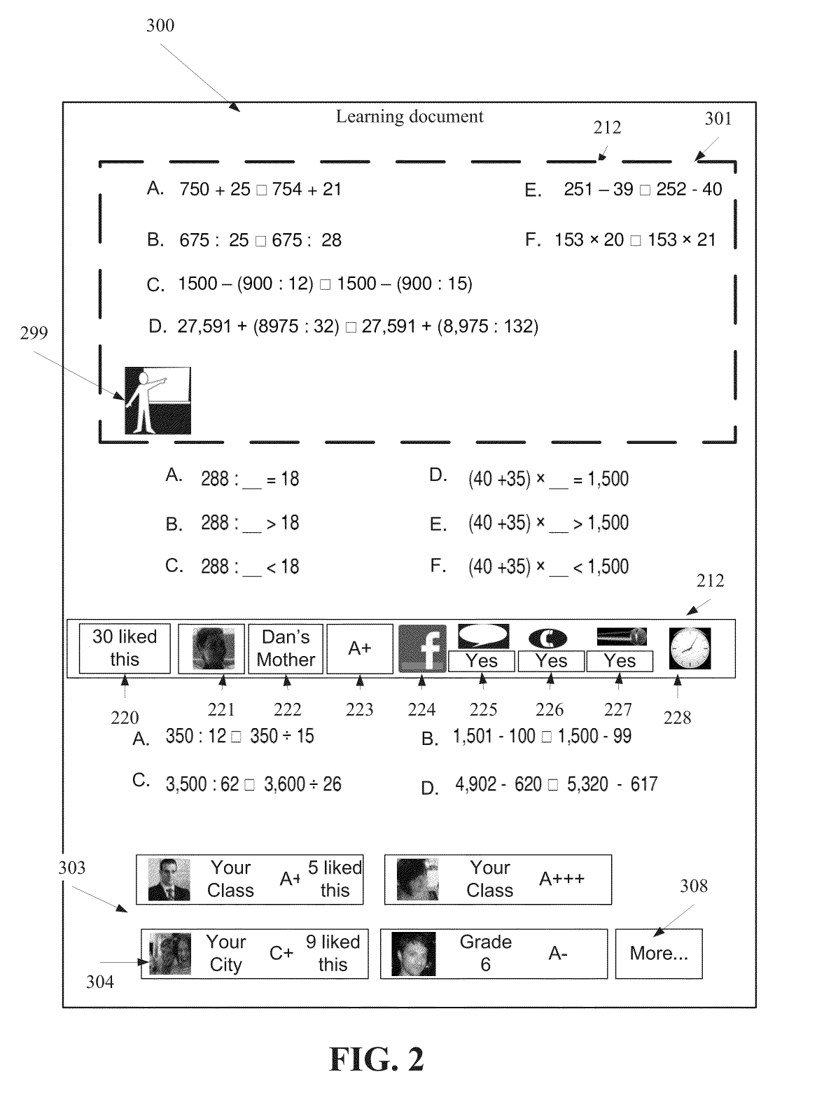

As used herein, a network available learning document, which is referred to herein for brevity as a learning document, may be any network accessible media which includes educational material, for example, a webpage, a scanned page of a book a pamphlet, and/or any printed educational material, for example a portable document format (PDF) document, a WORD document, and/or the like. An exemplary learning document 300 having an instructor ID tag 299 is depicted in FIG. 2. For brevity, the term learning document may refer to any element of learning document, for example an image, a graph, a flash component, a video file, an audio file, an active element such as asynchronous JavaScript and asynchronous extensible markup language (XML) (AJAX), and/or the like. For brevity, the term learning document may refer to any segment of a learning document, for example an exercise, one or more textual paragraph(s), a solution to an exercise, a chapter in an online book, and/or the like. An exemplary segment 301 of a learning document which is associated with an exemplary instructor ID tag (299) is depicted in FIG. 2. A learning document may be stored in a web server, for example available in a website and/or a learning document database 110 and/or via teaching platform 109, such as Time To Know™, Blackboard Learn™, Myngle, and/or the like.

An instructor ID tag which is added to a learning document is indicative that the tagging system user is willing to instruct (e.g. learn, teach, assist, and/or otherwise provide help and/or service) other system users who designate the instructor ID tag while watching the learning document, for example as described below. The added instructor ID tag allows system users to establish tutorial sessions with the system user who added instructor ID tag, for example automatically upon designation of the instructor ID tag, optionally if the respective system user is available.

An instructor ID tag enhanced learning document may be, for example, a web-based-book where at the beginning of each chapter, a series of instructor ID tags are added. The instructor ID tags may be, for example, images with names of people who have self-decided that they know something about this chapter and have registered themselves as being ready to help learners, for example kids. In use, a user, such as a kid, which is referred to this web-based-book for solving exercise, for instance as part of his homework and/or a preparation to an exam, is presented with these instructor ID tags and facilitated with the option to establish a tutorial session with one of the tagged instructors. Instructor ID tag(s) may be embedded in a certain learning document, presented with the certain learning document, for example on a toolbar, as a widget, and/or on a browser add-on.

For brevity, system users are divided herein to instructors and learners. As used herein, instructors are system users who use the education infrastructure 100, inter alia, to add instructor ID tag(s) to one or more learning document(s) and/or portions thereof. As used herein, learners are system users who use the infrastructure 100, inter alia, to request tutorial session(s) with one of instructor(s) by selecting instructor ID tag(s) which are presented in association with one or more learning document(s) and/or a portion(s) thereof. A learner which requests a tutorial session for one learning document and/or a portion thereof can be an instructor that assist other learner(s) with regard to other learning document(s) and/or portion(s) thereof and vice versa.

The central unit 101 is used for matching between instructors and learner, for example between a suitable instructor 122 and a learner 121 which use client terminals 108, 107. As used herein, a client terminal means a thin client, a laptop, a desktop, a Smartphone, a tablet, and/or any computing unit which has an access to a network 105. The central unit 101 is optionally implemented by one or more server(s) and/or terminal(s) which are connected to the network 105, such as the Internet. It should be noted that the central unit 101 may be implemented by a virtual machine (VM) and/or distributed on a number of servers and/or VMs. The central unit 101 includes one or more processor(s) 199, a tagging engine 103 for tagging learning documents and/or portions thereof, a matchmaking engine for matching between learners and instructors, for example based on learners selections, and a communication module 104 for establishing tutorial sessions which are related to learning documents between instructors and learners, for example as described below.

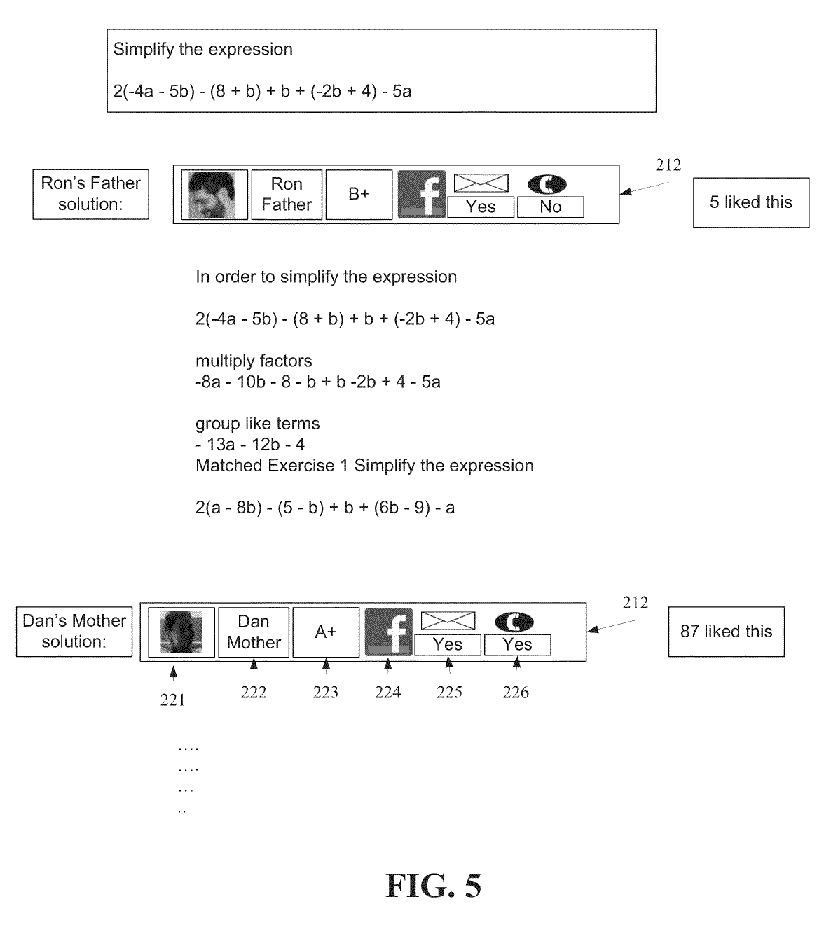

The tagging engine 103 adds instructor ID tags to learning documents in response to requests from users who are interested to instruct other users. Each instructor ID tag is associated with the user who requested to add it and with the certain learning document to which it is added. The association may be done by a reference, such as a uniform resource locator (URL), a unique ID and/or the like. The instructor ID tag, as further described below, allows establishing the tutorial session between the suitable instructor 122 and the learner 121, for example by instructing the communication module 104, for instance as described below. For example, a instructor ID tag may be a reference icon, as depicted by numeral 302 in FIG. 2, a dynamic reference icon that depicts real time data pertaining to the instructor and/or segment, for example depicted by numeral 303 in FIG. 2, an image of an instructor how is ready to participate in a tutorial session, and/or a reference bar that includes a number of informative and/or active graphical symbols, for example depicted by numeral 212 in FIGS. 2 and 5. As shown at 308, additional instructor ID tags may be hidden and presented upon demand.

The central unit 101 is optionally connected to and/or includes a reference record database 105 that associates between instructors and selected learning documents. For example, the reference record database 105 maps to which learning documents an instructor is ready to provide tutorial session and optionally, additional information about the performance of the instructor, for instance as described below.

Optionally, the central unit 101 is optionally connected and/or includes an instructor database 115 which stores information about instructors, for example a plurality of instructor records, each defines an instructor public profile that includes a name, a nickname, and/or any other identifier, a ranking, a number of “like” she received, and/or the like, a private profile that includes a log of tutorial session(s) she provided and/or the like. Each instructor record may also includes a link to a social page, demographic information of the instructor, for example age, one or more communities to which he belongs (e.g. association with a class, a school, a city, a country, and/or a street, of the instructor and/or of a family member thereof, for example of his offspring(s)).

Optionally, the central unit 101 is connected and/or includes an instructor content database 106 that includes content uploaded by the instructors. For example, the instructor content database 106 may include records, each associates a supporting material, such as a webpage, a word document, a video, an audio and/or a PDF and/or the like, which is associated with a certain learning document and contributing instructor(s). In use, for example as described below, the learning document may be presented to a learner who selects a related instructor ID tag during and/or before a tutorial session.

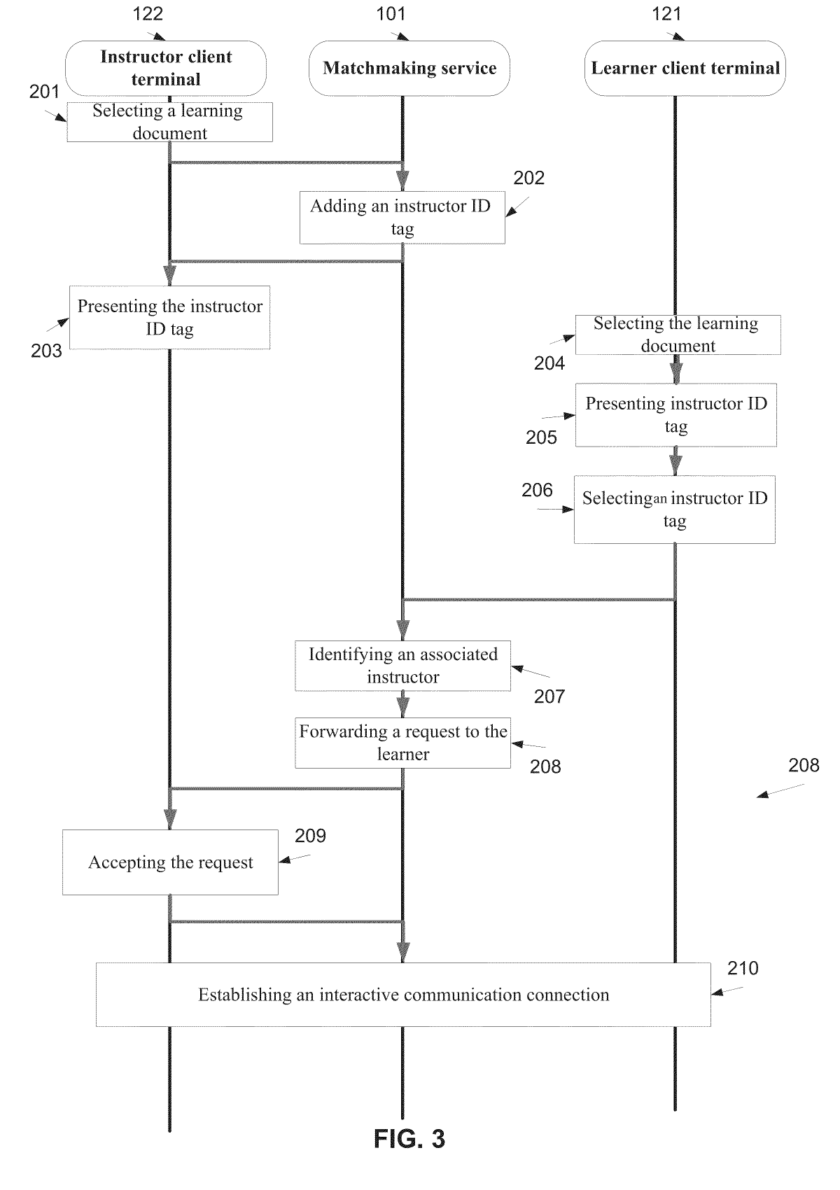

Reference is now also made to FIG. 3, which is a flowchart depicting an establishment of a tutorial session between an instructor 122 using client terminal 108 and a learner 121 using client terminal 107 based on a selection of a instructor ID tag added by the instructor to a certain learning document, according to some embodiments of the present invention.

First, as shown at 201, a system user selects a learning document. For example, a system user, an instructor, such as 122, may select a segment of a webpage or a section in a teaching platform, for instance one or more exercises in a webpage, for example see 301 in FIG. 2. The selection may be used using a graphical user interface (GUI) that is presented in a display of a client terminal, for example rendered using a browser hosted on a client terminal, such as 108. For instance, the GUI is a toolbar that is presented together with the learning document, for example embedded in the webpage that presents the learning document, provided as a browser add-on and/or added using downloaded software. Optionally, before a system user is facilitated with the option to select a learning document, it is authenticated, for example by a login process. In such embodiment, the identity of the system user is identified in advance, before she participates in a tutorial session. Optionally, a system user is required to provide identification means to reduce and/or avoid scams, pedophiles and/or other abusers. As described above, the system 10 may document various data pertaining to the system user, for example demographic data, ranking (between 1 to 5 for example), like achievements, and/or the like. The ranking is optionally based on inputs of learners, for example at the end of a tutorial session. The ranking is optionally an average grade that takes into account ranking(s) given by various learners to help system user(s) to choose good instructors over bad instructors. The ranking(s) also allow avoiding scams and marketing agents who pretend to be contributing instructors. The ranking may be based on an estimation that is based on the Curriculum Vitae (CV) of the instructor, on textual analysis of comments given by learners to his performances and/or on an analysis given by an estimator.

Optionally, some or all of the learning documents are associated with rules defining a profile of a system user that may add instructor ID tags thereto. For example, a learning document may be associated with a rule indicating that only a system user from a certain age, a certain school, with a certain ranking and/or a certain degree may add instructor ID tags thereto.

As shown at 202, the selection is now forwarded to the central unit 101 which adds accordingly an instructor ID tag to the segment. Optionally, this addition is documented in the reference record database 105, for example as a record having a reference to the segment and a unique ID of the instructor. As shown at 203, the instructor ID tag 302 may now be presented to the instructor 122 which added the instructor ID tag, indicating that the addition process is completed.

Reference is now made to an instructor ID tag selection session where a learner selects an instructor ID tag associated with an instructor and with a learning document and establishes a tutorial session with the associated instructor. As shown at 204 and 205, system users who access the tagged learning document, such as learner 121, are presented with instructor ID tag(s), for example as shown at 301 of FIG. 2. This allows the learner 121 to select an instructor by clicking, touching, or otherwise designating one of the presented instructor ID tag(s), for example as shown at 206. The instructor ID tags are optionally monitored by the central unit 101, for example includes a link or a call function that triggers the operation of the central unit 101.

Optionally, if the designated instructor ID tag is related to an instructor that is currently not online, a request message is sent thereto, optionally with the availability of the learner, for example as an email, an instant messaging (IM) message, a short message service (SMS) and/or any other contact means. This allows the instructor to accept and/or to reject the request and/or to propose a new time slot for a tutorial session, for example coordinating with a number of learners, for instance as known in the art. Optionally, the tutorial session is established automatically according to a scheduled time, for example by automatically calling the parties at the set time and establishing a conference call therebetween. Optionally, an instructor may refer the requestor to another instructor, for example sends a proposed instructor and/or the learner a message, for example as an email, an IM message, an SMS and/or any other contact means.

As described above, the instructor ID tag is associated with a certain instructor. Numeral 212 depicts an exemplary instructor ID tag, a reference icon bar with a number of optional instructor indications presented on a display of a client terminal, such as 107, to a potential learner, such as learner 121. The instructor indications may be extracted from a respective instructor record from an instructor database, for example the above described instructor database. For example, the reference icon bar 212 may indicate how many system users liked the content the respective instructor contributed 220, an image of the instructor 221, a relation of the instructor to the viewing learner and/or a relation of the instructor to the community of the viewing learner, for example her kinship to a class member, a ranking 223, for example a ranking among other instructors in the community and/or among all instructors, a link to a social network page 224, such as Facebook™, Google+™ and/or the like. Any of the icons in the reference icon bar 212 may be presented separately and/or in any combination with any of the other icons. The link to the social network page 224 may allow the learner to comment on the instructor and/or to indicate he “like” his performances.

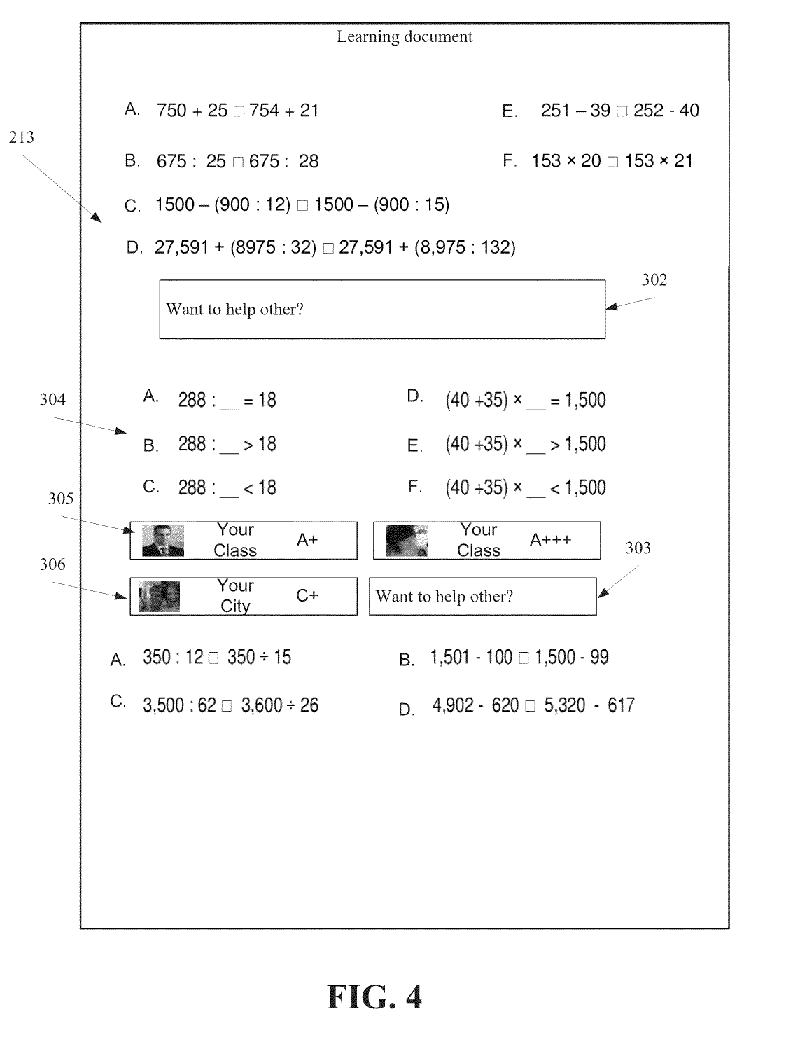

Numerals 305 and 306 in FIG. 4 depict a number of instructor ID tags which are added to a certain learning document 304 and indicative of ranking of a number of instructors. The ranking is optionally given in relation to the community to which both the instructor and the learner belongs. For example the ranking specified in instructor ID tag 305 is given to a father of a child that is in the same class of the learner and instructor ID tag 305 is given to an instructor from the same city of the learner. Optionally, a list of learners who studied with the instructor associated with a certain instructor ID tag is presented in association with the instructor ID tag, for example upon request. In such a manner, a system user can see who from his friends (and other system users) was assisted by the instructor.

Optionally, as shown at 303 of FIG. 2, a number of instructor ID tags may be presented simultaneously with reference to a certain segment, allowing the learner 121 to select a preferred instructor from a plurality of instructors, for example based on instructor indications such as ranking.

According to some embodiments of the present invention, a selection of an instructor ID tag is designed to establish a tutorial session with the instructor who added the respective instructor ID tag, for example automatically upon selection (e.g. a selection by a click made when a cursor of a pointing device is on the certain segment or on the instructor ID tag and/or by a touch event on a respective area of a touch screen display), for instance as described below. The tutorial session may be a voice over internet protocol (IP) (VoIP) call, a telephone call, a multimedia session, a call and/or a multimedia session that includes a shared workspace and/or the like.

Optionally, the selection is made by clicking, touching and/or otherwise designating an instructor ID tag holder element and/or button that is presented in association with a certain learning document. For example, numeral 302 in FIG. 4 depicts an exemplary instructor ID tag holder. Optionally, the instructor ID tag holder element is presented when no other instructor ID tag has been added to the learning document and/or with instructor ID tags which has been provided by other instructors, for example as shown at numeral 303 in FIG. 4.

Optionally, the learner is presented with the availability of each instructor, for example whether she is available for participating in a tutorial session now and/or when she is available for participating in a tutorial session in the future. This information may be provided by the instructor and documented in the respective instructor record and optionally accessed upon demand.

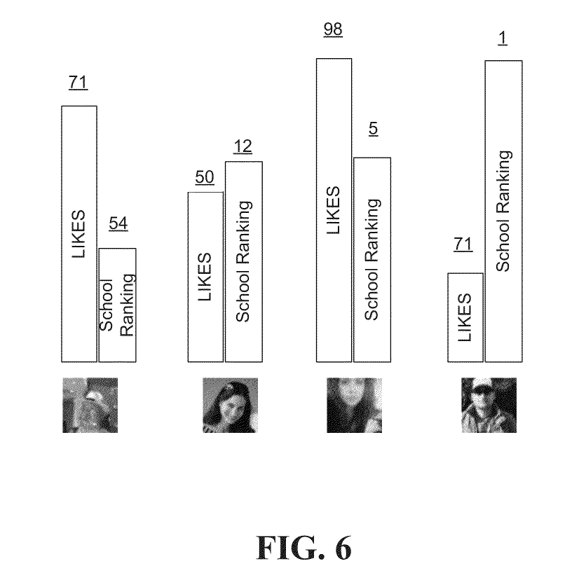

Optionally, the learner is presented with a selection of instructors who added instructor ID tags to the respective learning document. Each instructor ID tag may present a ranking that allows a learner to compare contribution of a respective instructor to other instructors. For example, FIG. 6 is a schematic illustration of a comparative view that indicates the ranking of different instructors and the number of likes each instructor receives for the tutorial sessions she provides, for example as shown at 220 in FIG. 2.

The selection is forwarded to the central unit 101 via the network, facilitating the identification of the instructor who is associated with the instructor ID tag, for example by the matching reference record, as shown at 207. This allows, as shown at 208, to forward a request to establish a tutorial session to the instructor who is associated with the instructor ID tag. For example, the selection is indicative of the type of requested tutorial session. For example, selecting icon 226 is indicative of a request to establish VoIP connection and icon 225 is indicative of a request to establish IM connection.

Now, as shown at 208, a request to establish a tutorial session is forwarded to the instructor who is associated with the instructor ID tag, for example as an IM message, a call, an SMS, and/or an email. This allows the instructor to accept the request, as shown at 209, for example by responding to the request and/or by establishing a connection with the central unit 101, for example via her client terminal 108.

After the request is accepted, the tutorial session is established, as shown at 210. Optionally, for example as part of the tutorial session, the learner is referred to a designated support material provided by the instructor and/or by other instructors. For example, FIG. 5 depicts an exemplary support material page that may be presented to the learner and/or to the instructor during the tutorial session. The support material is optionally stored in the instructor content database 106. The support material may include textual content, visual content (e.g. images and video), audible content and/or any other material that is selected and/or contributed by the instructor.

Optionally, the learner may now (or optionally in any other time) rank the instructor and/or otherwise express his appreciation, for example mark a like on the instructor's tutorial session and/or on the instructor itself.

Optionally, the learner reports inappropriate content that is uploaded as an instructor content and/or inappropriate and/or nonprofessional behavior of the instructor during the tutorial session. The reporting may be performed by pressing on a designated button and/or any other user interface (UI).

Optionally, tutorial sessions are recorded and published, for example in association with the respective instructor ID tag of the instructor for other learners to view, for example when the instructor is not available. Optionally, this recording and/or publishing depend on an approval of the recorded instructor and/or learner. For example, icon 227 in FIG. 2 allows a selecting user to listen and/or watch to a recording to a tutorial session made between the instructor and another system user.

Optionally, tutorial sessions are provided for free.

Optionally, instructors are compensated for giving tutorial sessions, for example according to a billing module which monitors the provided tutorial sessions.

Optionally, instructors are compensated for giving tutorial sessions, for example according to a billing module which monitors the provided tutorial sessions. The compensation may be based on the ranking an instructor receives from a user. The compensation may be charged from the learner, from an account details associated with the learner, and/or from an educational fund. Optionally, the system users are subscribers who pay for a periodic subscription to a service where tutorial sessions are provided by subscribers. In such embodiments, instructors may be geographically separated from the learners. For example, while the instructor is located in England, the learner may be located in Dubai.

Optionally, during a tutorial session, an image of the learner is presented in association with the image of the instructor. This allows potential learners who access the respective learning document to receive an indication that other learner(s) acre currently being instructed.

According to some embodiments of the present invention, a tutorial session is established between an instructor and a plurality of learners, for example 2, 5, 10 or any intermediate or larger number of learners. In such an embodiment, a learner joins a tutorial session which already initiated between the instructor and one or more other learners. Additionally or alternatively, an instructor sets a tutorial session for a certain time and the time may be presented in association with the respective instructor ID tag, for example to a user who clicks and/or touches a respective icon, for example as shown at 228 of FIG. 2. This allows one or more learners to join a multi participate tutorial session, for example a multi participate video conference and/or a multi participate shared board and/or presentation that can be viewed by one or more learners during the tutorial session.

According to some embodiments of the present invention, an indication of system users who are currently accessing a certain learning document is presented to a new system user who accesses the certain learning document. In such an embodiment, a learner may registered to the system, for example through a social network account, such as Facebook™, Google+™, and/or another social network, and/or log into the system before and/or during the access to a learning document. In such embodiments a learner, for example a student receives indications which of her classmates are busy on the same learning document so she knows she is not the only one who currently studies this material.

Optionally, if no activity from a certain system user is sensed for a certain period, for example 10 minutes, or so she is removed from being marked as currently accessing a certain learning document. Optionally, a tutorial session may be established between two or more system users, for example similarly to the described above. Ranking to instructors may now be provided to assisting system user, for example similarly to the described above. This maybe a social ranking related to the teaching values of the instructing system users.

The methods as described above are used in the fabrication of integrated circuit chips.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant methods and systems will be developed and the scope of the term a module, a processor, a unit, a network, a selection and a tag is intended to include all such new technologies a priori.

As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A method for enabling users to offer educational support in response to a designation of instructor identifier (ID) tags associated with network accessible learning documents, said method comprising:
selecting by a first user using a first client terminal a network accessible learning document;
associating an instructor ID tag indicative of said first user with said network accessible learning document;
instructing a presentation of said instructor ID tag in association with the presentation of said network accessible learning document to a second user accessing said network accessible learning document via a second client terminal;
identifying a user selection designating said instructor ID tag and made by said second user; and
establishing a tutorial session which is based on an interactive communication connection between said first user and said second user.

2. The method of claim 1, wherein said instructor ID tag is associated with a portion of a network accessible learning document; wherein said instructing comprises instructing a presentation of said instructor ID tag in association with the presentation of said portion to said second user.

3. The method of claim 1, wherein a ranking given to said first user by a plurality of users participating in a plurality of tutorial sessions therewith is presented in association with said instructor ID tag.

4. The method of claim 1, further comprising identifying a community to which both said first and second belongs and presenting an indication of said community to said second user in association with said instructor ID tag.

5. The method of claim 1, wherein said establishing comprises identifying support material loaded by said first user in relation to said network accessible learning document and presenting said support material to said second user during said tutorial session.

6. The method of claim 1, wherein said instructor ID tag is presented by a browser displaying said network accessible learning document while said network accessible learning document is displayed.

7. The method of claim 1, wherein network accessible learning document comprises a plurality of tag holders, said selecting is performed in response to a selection of one of said plurality of tag holders by said first user.

8. The method of claim 1, further comprising recoding said tutorial session and making said recorded tutorial session available to a third user who accesses said network accessible learning document via a third client terminal.

9. The method of claim 1, further comprising presenting an indication of a participation of said second user in said tutorial session to a third user accessing said network accessible learning document via a third client terminal.

10. The method of claim 1, wherein said learning document is managed by a teaching platform.

11. The method of claim 1, wherein said network accessible learning document is a page in multipage document, said network accessible learning document is one of a plurality of segments of said page where each said segment is associated with at least different instructor ID tag indicative of and added by at least additional user.

12. The method of claim 1, further comprising:
selecting said network accessible learning document by a plurality of third users using a plurality of different client terminals;
associating a plurality of instructor ID tags each indicative of another of said plurality of third users; and
instructing a presentation of said plurality of instructor ID tags in association with the presentation of said network accessible learning document to said second user during an access to said network accessible learning document;
wherein said user selection designating one of said plurality of instructor ID tags.

13. The method of claim 1, wherein said instructor ID tag is added to a plurality of ID tags which are added by and indicative of a plurality of different users.

14. The method of claim 1, wherein said learning document is selected from a group consisting of a webpage, a scanned page of a book a pamphlet, a printed educational material, a portable document format (PDF) document, and a WORD document.

15. The method of claim 1, wherein said instructor ID tag is presented in association with the presentation of said network accessible learning document to a plurality of second users accessing said network accessible learning document via a plurality of different second client terminals.

16. The method of claim 15, wherein said identifying comprises identifying a plurality of user selections designating said instructor ID tag from said plurality of different second client terminals and said establishing comprises establishing said tutorial session with said plurality of second users as a multi participant session.

17. The method of claim 1, wherein said establishing comprises automatically forwarding to said first user a request message in response to said user selection, said request message indicates a request from at least one second user for an interactive tutorial pertaining to said network accessible learning document; wherein said establishing is performed based on the acceptance of said request.

18. The method of claim 1, further comprising scheduling a time for said tutorial session according to input received from at least one of said first user and said second user; wherein said establishing is automatically performed according to said scheduling.

19. A system for enabling users to offer educational support in response to a selection of one or more instructor identifier (ID) tags associated with one or more network accessible learning documents, said system comprising:
a repository which documents a plurality of instructor ID tags each indicative of an association between one of a plurality of learning documents and one of a plurality of system users, each said instructor ID tag is set to be presented in association with a respective said learning document from said plurality of learning documents;
a tagging module which allows each one of said plurality of system users to add at least one of said plurality of instructor ID tags to at least one of said plurality of learning documents; and
an interactive communication connection module which receives via a network a user selection designating a certain of said plurality of instructor ID tags and triggers the establishing of a tutorial session between a tag selecting user who made said user selection and a system user of said plurality of system users which is associated with said certain instructor ID tag.

20. A computer program product for enabling users to offer educational support in response to a selection of instructor identifier (ID) tags associated with network accessible learning documents, comprising:
a computer readable storage medium;
first program instructions to select by a first user using a first client terminal a network accessible learning document;
second program instructions to associate an instructor ID tag indicative of said first user with said network accessible learning document;
third program instructions to instruct a presentation of said instructor ID tag in association with the presentation of said network accessible learning document to a second user accessing said network accessible learning document via a second client terminal;
fourth program instructions to identify a user selection designating said instructor ID tag and made by said second user; and
fifth program instructions to establish a tutorial session which is based on an interactive communication connection between said first user and said second user in response to said user selection;
wherein said first, second, third, fourth and fifth program instructions are stored on said computer readable storage medium.

21. A method adding a tutorial session support layer to a network accessible learning, comprising:
selecting a network accessible learning document by each of a plurality of contributing users in a plurality of separate events;
associating a plurality of instructor ID tags with said network accessible learning document, each said instructor ID tag is further associated with one of said plurality of contributing users;
instructing a presentation of said plurality of instructor ID tag in association with the presentation of said network accessible learning document on a client terminal to an additional user accessing said network accessible learning document;
selecting a first of said plurality of instructor ID tags by said additional user; and
establishing a tutorial session which is based on an interactive communication connection between said additional user and a first of said plurality of contributing users which is associated with said first instructor ID tag.

22. The method of claim 21, wherein each said instructor ID tags includes an indication of a ranking of a respective said contributing user.

23. The method of claim 21, wherein each said instructor ID tags includes an indication of a current availability of a respective said contributing user.

24. The method of claim 21, wherein each said instructor ID tags includes an indication of a relation between a respective said contributing user and said additional user.
